(19) United States
(12) Patent Application Publication
(10) Pub. No.: US 2010/0039664 A1
(43) Pub. Date: Feb. 18, 2010

(54) IMAGE FORMING APPARATUS, ADDRESS STORING METHOD AND COMPUTER-READABLE RECORDING MEDIUM RECORDING ADDRESS STORING PROGRAM

(75) Inventor: Hisataka Funakawa, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/538,685

(22) Filed: Aug. 10, 2009

(30) Foreign Application Priority Data
Aug. 13, 2008 (JP) 2008-208415

(51) Int. Cl. G06K 15/02; G06F 17/00

(52) U.S. Cl. 358/1.15; 715/234; 715/273

(57) ABSTRACT

An image forming apparatus includes a memory, an operation unit for accepting first and second commands, a communication interface for receiving a Web page from an external address over a network based on the first command, a display for displaying the received Web page, a detecting unit for detecting input of the second command relating to the Web page during display of the Web page, and a storage control unit for storing an address of the Web page as historical information in the memory, when the detecting unit detects input of the second command relating to the Web page during display of the Web page.

This application is based on Japanese Patent Application No. 2008-208415 filed with the Japan Patent Office on Aug. 13, 2008, the entire content of which is hereby incorporated by reference.

### BACKGROUND OF THE INVENTION

1. Field of the Invention

The present invention relates to an image forming apparatus connectable to a network, an address storing method and a computer-readable recording medium recording an address storing program. Particularly, the invention relates to an image forming apparatus that stores addresses of Web pages obtained over a network, an address storing method in the image forming apparatus and a computer-readable recording medium recording an address storing program executed by the image forming apparatus.

2. Description of the Related Art

An image forming apparatus in which a Web browser is available has been known as a kind of image forming apparatus that has a function of accessing an external Web server over a network. In such an image forming apparatus, a display unit displays information (Web pages) downloaded over the network, using the Web browser. A printing unit prints the downloaded Web pages. The Web browser stores historical information about the displayed Web pages (i.e., addresses and names of the Web pages). Thereby, a user who intends to access the Web pages again can select an intended address from among a plurality of stored addresses. Consequently, the user can easily browse the Web pages that were browsed before, without manually entering each intended address.

However, when the image forming apparatus stores all the addresses of the browsed Web pages as historical addresses, the quantity of the stored historical addresses becomes large, and a memory capacity required for storing the historical addresses increases. Further, a long time is required for the user to find an intended address among the historical addresses. Accordingly, a technique for storing the historical addresses of the Web pages has been proposed.

For example, Japanese Laid-Open Patent Publication No. 11-015847 (document 1) has disclosed a history saving method for HTML contents. According to Japanese Laid-Open Patent Publication No. 11-015847 (document 1), contents formed of a plurality of files described in HTML that operates on the Web browser have at least two, i.e., first and second frames, and there are employed means for instructing, in response to a user's operation, changing of the HTML file read in the above first frame into another HTML file, and means for storing data corresponding to a history of the user's operation performed for the above first frame in the HTML file read in the second frame. The contents have means for determining, according to a display duration time, whether the history of the HTML file displayed on a screen is to be saved or not.

As described above, there has been the technique for storing the addresses of the Web pages that were browsed for a predetermined time or duration or more. However, details of the contents and the screen structure of each Web page are different from those of the other Web pages so that the address of the Web page required by the user may not be stored. For example, when Web pages primarily contain texts, the user must browse the Web pages for a relative long time for grasping the contents even if importance thereof is low. Conversely, when the Web pages primarily contain photographs or illustrations, the user can grasp the details of the Web pages within a short time even if importance thereof is high. As described above, the conventional history saving method may suffer from a problem that addresses of the Web pages of low importance are stored and addresses of Web pages of high importance are not stored.

### SUMMARY OF THE INVENTION

The present invention has been made for overcoming the above problem, and an object of the invention is to provide an image forming apparatus that can efficiently store historical addresses and thereby allows efficiently re-access to the historical address by a user, as well as an address storing method and computer-readable recording medium recording an address storing program.

According to an aspect, the invention provides an image forming apparatus. The image forming apparatus includes a memory, an operation unit for accepting first and second commands, a communication interface for receiving a Web page from an external address over a network based on the first command, a display for displaying the received Web page, a detecting unit for detecting input of the second command relating to the Web page during display of the Web page, and a storage control unit for storing an address of the Web page as historical information in the memory, when the detecting unit detects input of the second command relating to the Web page during display of the Web page.

Preferably, the second command relating to the Web page includes a command for changing a display area.

Preferably, the second command relating to the Web page includes a command for changing a display size of a font.

Preferably, the second command relating to the Web page includes a command for searching a word on the Web pages.

Preferably, the storage control unit stores the address of the first displayed Web page as the historical information in the memory.

Preferably, the storage control unit stores the address of the last displayed Web page as the historical information in the memory.

Preferably, the image forming apparatus further includes a printer for printing the historical information stored in the memory. The storage control unit deletes the printed historical information from the memory.

Preferably, the image forming apparatus further includes a printer for printing the Web page. The second command relating to the Web page includes a command for printing the currently displayed Web page.

Preferably, the operation unit accepts a display command for displaying the historical information. The display displays the historical information read from the memory in accordance with the display command.

According to another aspect, the invention provides an image forming apparatus. The image forming apparatus includes a memory, an operation unit for accepting an operation command, a communication interface for receiving a Web page from an external address over a network based on the operation command, a display for displaying the received Web page, a measuring unit for measuring a time for which the Web page is displayed, a first determining unit for determining whether the time of display of the Web page is longer than a first predetermined time or not, and a storage control unit for storing the address of the Web page as the historical information in the memory, when the time of display of the Web page is longer than a first predetermined time.

According to still another aspect, the invention provides an image forming apparatus includes a memory, an operation unit for accepting an operation command, a communication interface for receiving successively Web pages from an external address over a network based on the operation command, a display for displaying the received Web page, a second determining unit for determining whether a level of the address of the newly displayed Web page is deeper than a level of the address of the last displayed Web page or not, and a storage control unit for storing the address of the last displayed Web page as the historical information in the memory, when the level of the address of the newly displayed Web page is not deeper than the level of the address of the last displayed Web page.

According to yet another aspect, the invention provides an image forming apparatus. The image forming apparatus includes a memory, a communication interface for successively receiving at least one Web page from an external address over a network based on an operation command, a display for displaying each of the at least one received Web page; an operation unit for accepting, as the operation command, a selection command for selecting a link of each of the at least one Web page, a count unit for counting the number of the selected links of each of the at least one Web page, a third determining unit for determining whether the number of the selected links is more than a predetermined number or not, and a storage control unit for storing the address of the Web page having the selected links as the historical information in the memory, when the number of the selected links is more than the predetermined number.

According to a further aspect, the invention provides an address storing method in an image forming apparatus including a memory, a display and a communication interface. The address storing method includes the steps of receiving a Web page from an external address through the communication interface over a network based on a first command, displaying the received Web page on the display, detecting acceptance of a second command relating to the Web page during display of the Web page, and storing an address of the Web page as historical information in the memory, when accepting the second command relating to the Web page during display of the Web page.

Preferably, the second command relating to the Web page includes a command for changing a display area.

Preferably, the second command relating to the Web page includes a command for changing a display size of a font.

Preferably, the second command relating to the Web page includes a command for searching a word on the Web pages.

Preferably, the address storing method further includes a step of storing the address of the first displayed Web page as the historical information in the memory.

Preferably, the address storing method further includes a step of storing the address of the last displayed Web page as the historical information in the memory.

Preferably, the image forming apparatus includes a printer. The address storing method further includes the steps of printing the historical information stored in the memory by the printer, and erasing the printed historical information from the memory.

According to a further aspect, the invention provides a computer-readable recording medium recording address storing program for causing an image forming apparatus including a processor unit, a memory, a display and a communication interface to store an address. The address storing program causes the processor to execute the steps of receiving a Web page from an external address through the communication interface over a network based on a first command, displaying the received Web page on the display, detecting acceptance of a second command relating to the Web page during display of the Web page, and storing an address of the Web page as historical information in the memory, when accepting the second command relating to the Web page during display of the Web page.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a schematic structure of an image forming system according to a first embodiment of the invention.

FIG. 2 is a diagram showing a hardware structure of the image forming apparatus according to the first embodiment.

FIG. 3 schematically shows an operation panel according to the first embodiment.

FIG. 4 is a first image view showing a display screen of a display in a normal mode.

FIG. 5 is an image view showing a display screen of the display in a history mode.

FIG. 6 is a block diagram showing a functional structure of the image forming apparatus according to the first embodiment of the invention.

FIG. 7 is an image diagram showing a data structure of browse address data stored in a memory.

FIG. 8A is an image view showing a state of scrolling a display area, and FIG. 8B is an image view showing a state of expanding the display area.

FIG. 9 is a second image view showing a display screen of the display in a normal mode.

FIG. 10 is a first image diagram showing a hierarchical relationship of addresses of Web pages downloaded from a Web server.

FIG. 11 is a second image diagram showing the hierarchical relationship of the addresses of Web pages downloaded from the Web server.

FIG. 12A is a first image view showing historical addresses printed by a printing unit, and FIG. 12B is a second image view showing the historical addresses printed by the printing unit.

FIG. 13 is a flowchart showing a processing procedure of address storage processing in the image forming apparatus according to the first embodiment.

FIG. 14 is a flowchart showing a processing procedure of historical address printing processing in the image forming apparatus according to the first embodiment.

FIG. 15 is a flowchart showing a processing procedure of address storing processing in an image forming apparatus according to a second embodiment.

### DESCRIPTION OF THE PREFERRED EMBODIMENTS

Embodiments of the invention will be described below with reference to the drawings. In the following description, the same or corresponding portions bear the same reference numbers, and description thereof is not repeated.

### First Embodiment

(Whole Structure of an Image Forming System)

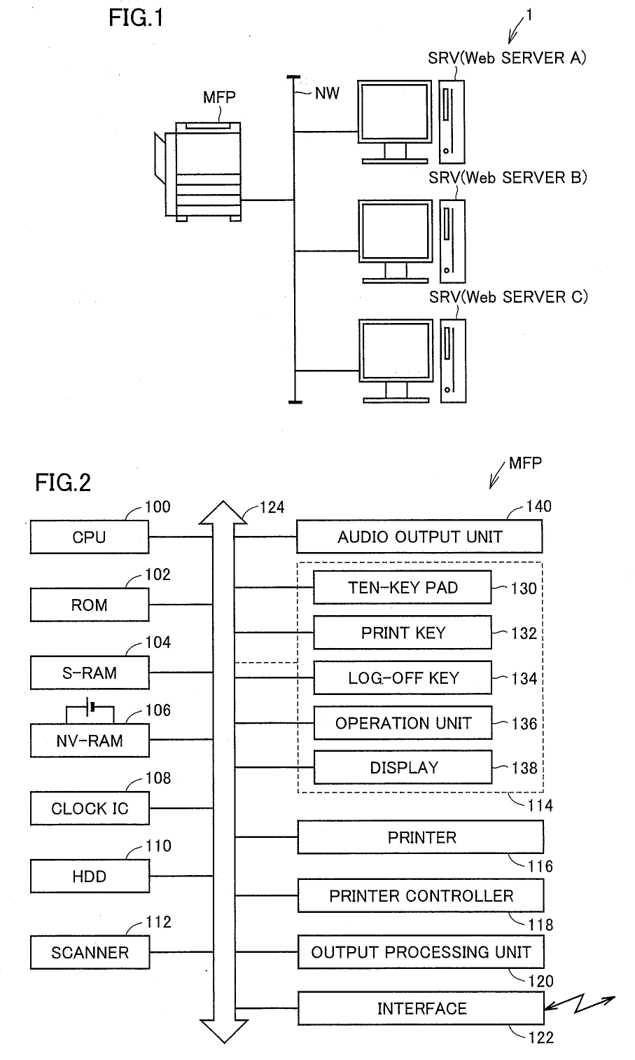

Description will now be given on a whole structure of an image forming system according to a first embodiment. FIG. 1 shows a schematic structure of an image forming system 1 according to the embodiment of the invention.

Referring to FIG. 1, image forming system 1 is formed of an image forming apparatus MFP, and a Web server SRV connected to image forming apparatus MFP over a network NW.

Web server SRV and image forming apparatus MFP are configured to allow mutual data communications. Network NW is formed of a dedicated line such as an LAN (Local Area Network) and a WAN (Wide Area Network) as well as a public line such as the Internet and a virtual private network, which may be entirely or partially formed of wireless communication lines such as a wireless LAN.

Image forming apparatus MFP is typically an Multi Function Peripheral (MFP) equipped with a plurality of functions such as a facsimile function and a scanner function. Image forming apparatus WP transmits to Web server SRV a request for taking out data stored in Web server SRV, i.e., for obtaining the data. Image forming apparatus MFP performs display processing or image forming processing based on the data obtained from Web server SRV. The image forming processing includes printing on a paper medium, transmission to a facsimile and the like.

Image forming apparatus MFP according to the embodiment is configured to be connectable to a plurality of Web servers SRV (e.g., Web servers A, B, . . . ) over network NW including the Internet. Each Web server is assigned a predetermined address for identifying Web server SRV. Web server SRV stores various Web pages including image data and text data. Each Web page is assigned a predetermined address (URL). Web server SRV reads the Web page at a designated address in response to a request from image forming apparatus MFP, and transmits the read Web page to image forming apparatus MFP.

Image forming apparatus MFP has a Web browser as a function for requesting Web server SRV to provide Web pages. Image forming apparatus MFP downloads the Web pages from Web server SRV, using the Web browser. Image forming apparatus MFP displays and/or prints the downloaded Web pages.

Particularly, when image forming apparatus MFP according to the embodiment downloads the Web page, it handles the address of the Web page as a browse address. Image forming apparatus MFP stores or holds, as historical addresses (historical information), the addresses of Web pages that are important for the user, i.e., the addresses of Web pages that attracted user's interest.

Storing the address as the historical address is the same as storing the address in a reusable fashion in a memory and is the same as, e.g., holding the address in a state that allows re-access the Web page based on the address.

Alternatively, the browse address is temporarily stored when image forming apparatus MFP downloads the Web page. Conversely, the historical address is stored in a state that it is available even after image forming apparatus MFP downloaded the Web page.

Alternatively, the browse address is stored in a volatile first memory. The historical address is stored in a nonvolatile second memory.

Also, the browse address is deleted when the operation of the Web browser ends. The historical address is held in the state that it is available, even after the operation of the Web browser ends.

Structures for implementing the above functions will be described below in detail.

(Hardware Structure of Image Forming Apparatus MFP)

The hardware structure of image forming apparatus MFP according to the embodiment will now be described below. FIG. 2 is a diagram showing the hardware structure of image forming apparatus MFP according to the embodiment,

Referring to FIG. 2, image forming apparatus MFP includes a CPU (Central Processing Unit) 100, a ROM (Read Only Memory) 102, an S-RAM (Static-Random Access Memory) 104, an NV-RAM (Non-Volatile Random Access Memory) 106 and a clock IC (Integrated Circuit) 108. These portions are connected together via a bus 124.

CPU 100 loads a program prestored in ROM 102 or the like into a work memory, i.e., S-RAM 104 and executes it for implementing the processing according to the invention. NV-RAM 106 nonvolatilely stores various settings relating to the image formation in the MFP. Clock IC 108 includes a crystal oscillator or the like for measuring a present time.

Image forming apparatus MFP includes a scanner 112, an operation panel 114, a printer 116, a printer controller 118 and an output processing unit 120.

Scanner 112 reads an original document to produce an image data. Although not shown, scanner 112 typically includes a carrier for setting original documents thereon, a document table glass, a transporter for automatically feeding the documents on the carrier onto the document table glass one by one, and a discharge table onto which the read documents are discharged.

Operation panel 114 includes a ten-key pad 130, a PRINT key 132, a log-off key 134, an operation unit 136 and a display 138 in an integrated fashion, and is arranged at a surface of image forming apparatus MFP. Ten-key pad 130, PRINT key 132, log-off key 134 and operation unit 136 function as an input unit accepting user's operations.

Operation unit 136 is formed of, e.g., a transparent touch panel. Operation unit 136 accepts an address of a Web page entered by the user when image forming apparatus MFP downloads the Web page. S-RAM 104 temporarily stores an address accepted by operation unit 136.

Display 138 displays contents for urging the user to perform various settings or selections. Display 138 is typically formed of an LCD (Liquid Crystal Display), and operation unit 136 is arranged on a display surface of display 138. Display 138 displays the downloaded Web pages.

Printer 116 prints an image on a paper medium, and typically includes an image forming unit formed of an exposure unit and a developing roller, a transfer roller transferring a toner image formed by the image forming unit onto the paper medium, a fixing unit fixing the transferred toner image and a control circuit controlling operations of various portions.

Printer controller 118 converts the print data (Web page) provided from Web server SRV or a personal computer as well as the image data scanned by scanner 112 into data suitable for the printing processing by printer 116. Typically, when image forming apparatus MFP is of a color type, printer controller 118 converts the print data (Web page) or other image data into four-color raster data of yellow (Y), magenta (M), cyan (C) and black (K), and outputs the raster data of each color to printer 116.

Output processing unit 120 performs processing on the paper medium on which the image is already formed by printer 116, and typically executes “sort processing”, “group processing”, “staple processing”, “punch processing” and the like. The “sort processing” is performed, e.g., when multiple copies of a document having multiple pages are to be output, for outputting the plurality, i.e., the set number of copies of the document of the paper mediums bearing images according to the same page arrangement as the original document. This processing means a copy-by-copy printing. The “group processing” is processing for outputting a group of the set number of paper mediums of the same page at a time. The “staple processing” is processing of stapling the output paper mediums, and the “punch processing” is processing of forming binding holes in the output paper mediums.

Further, image forming apparatus MFP includes a Hard Disk Drive (HDD) 110 and a communication interface 122.

Hard disk drive 110 nonvolatilely stores a relatively large amount of data, and stores the Web pages provided from Web server SRV, the image data read by scanner 112 and the like. Communication interface 122 communicates with the personal computer and Web server SRV over network NW.

When the apparatus downloads the Web page from Web server SRV, S-RAM 104 temporarily stores, as the browse address, the address at which the Web page is stored. Further, S-RAM 104 temporarily stores the Web pages downloaded from Web server SRV. When the apparatus accepts a predetermined operation of the user while a Web page is being displayed, NV-RAM 106 or hard disk drive 110 stores the address corresponding this displayed page as the historical address in a fashion allowing the calling.

An audio output unit 140 is formed of a speaker and the like, and outputs a guidance voice relating to a manner of use of image forming apparatus MFP itself and functions mounted in image forming apparatus MFP as well as an alarm sound.

Owing to the above structure, CPU 100 displays, on display 138 of operation panel 114, the Web page that is downloaded by accessing the designated address of Web server SRV. Based on the operation command of the user accepted via operation unit 136 of operation panel 114, CPU 100 changes the Web page (by downloading a new Web page), or scrolls the Web page displayed by display 138. CPU 100 monitors the operation commands entered via operation unit 136, and stores the browse address as the historical address in NV-RAM 106 or hard disk drive 110 in response to a predetermined operation command. Display 138 displays the historical address in response to the display command entered via operation-unit 136. Likewise, printer controller 118 performs the image forming processing on the historical address and the Web page, and printer 116 prints the historical address and the Web page on a paper sheet.

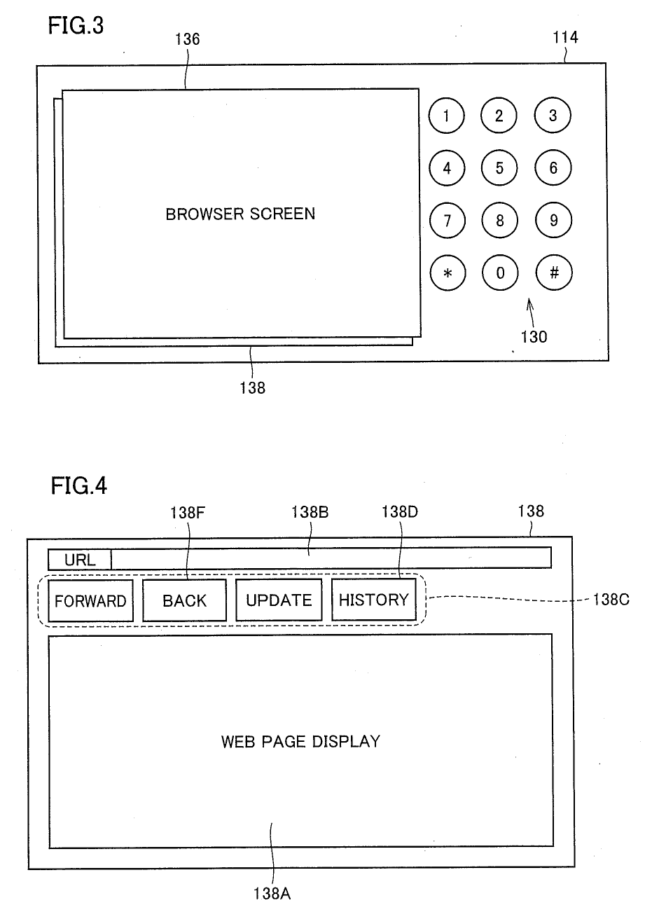

Operation panel 114 will be described below. FIG. 3 schematically shows operation panel 114. As described before, operation panel 114 displays the browse addresses, Web pages and historical addresses by display 138. The browse address is displayed based on the input data from the user. The Web pages and the historical addresses are displayed based on the data provided from CPU 100.

Operation panel 114 accepts the address of Web page, a selection command for selecting a linked site included in the Web page, and a scroll command for moving a display area of the Web page through operation unit 136 superimposed on display 138. Operation unit 136 provides an operation command entered by the user to CPU 100.

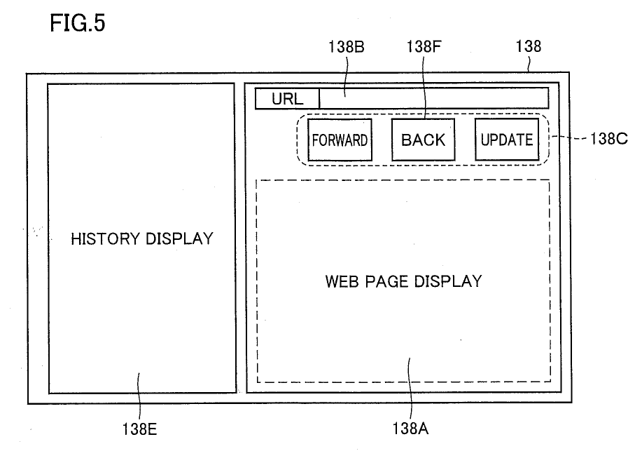

FIG. 4 is a first image view showing a display screen of display 138 in a normal mode. Referring to FIG. 4, in the normal mode, display 138 displays a Web page display area 138A located in a center of the screen for displaying a Web page, and also displays, in an upper portion of the screen, an address input area 138B for entering/displaying the address of the Web page and operation buttons 138C for updating the Web page or displaying the last or next Web page. More specifically, in the normal mode, display 138 displays a history display button 138D for displaying the historical addresses of the browsed Web pages, a back button 138F and the like.

By operating history display button 138D, the user can change a normal mode into the history mode (to be displayed later) for the display by display 138.

FIG. 5 is an image view showing the display screen of display 138 in the history mode. Referring to FIG. 5, in the history mode, display 138 displays Web page display area 138A located on a lower right portion of the screen for displaying a Web page, and also displays, on an upper right portion of the screen, address input area 138B located for entering/displaying the address of the Web page, and operation buttons 138C used for updating the Web page or displaying the previous or next Web page. In the history mode, display 138 displays, on a left portion of the screen, a history address display area 138E for displaying the historical addresses of the browsed Web pages.

The user can operate back button 138F to change the display mode of display 138 to the normal mode.

(Functional Structure of Image Forming Apparatus MFP)

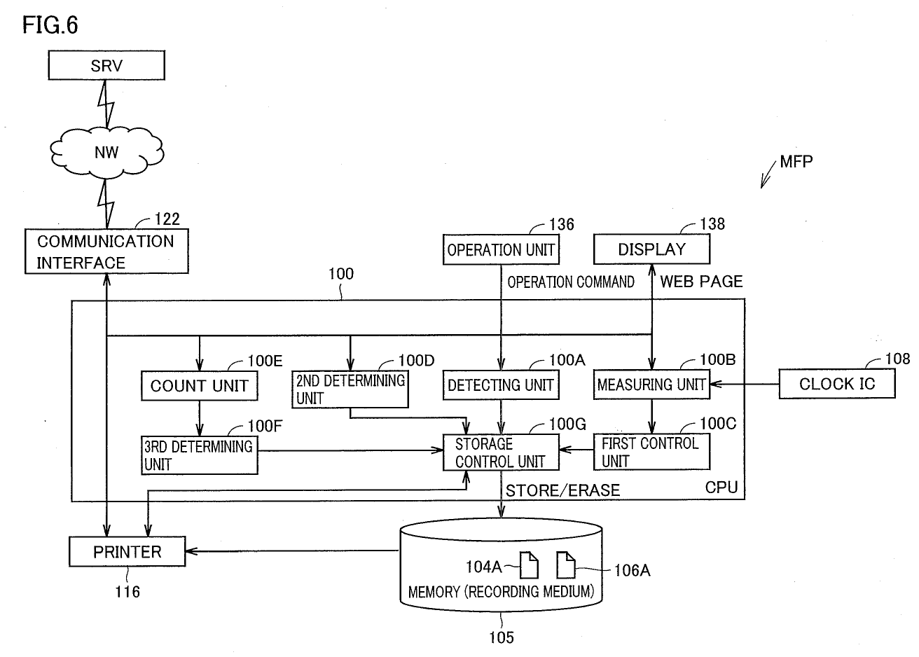

Description will now be given on the functional structure of image forming apparatus MFP according to the embodiment. FIG. 6 is a block diagram showing a functional structure of image forming apparatus MFP according to the embodiment of the invention. Referring to FIG. 6, image forming apparatus MFP includes the functions of communication interface 122, operation unit 136, display 138, printer 116, clock IC 108, a detecting unit 100A, a measuring unit 100B, a first determining unit 100C, a second determining unit 100D, a count unit 100E, a third determining unit 100F, a storage control unit 100G and a memory (recording medium) 105.

As described before, operation panel 114 implements operation unit 136 and display 138. Operation unit 136 accepts an access command including the address of the Web page, a display command for displaying the Web pages and historical addresses, a command for changing the display state of the Web page, a print command for printing the Web page and historical addresses, and various setting commands relating to the printing. For example, display 138 displays the Web page based on the data of the Web page that is received from an external address (Web server SRV) over network NW and communication interface 122. Display 138 displays a list of the historical addresses based on the display command entered through operation unit 136.

CPU 100 reads the programs prestored in ROM 102 or hard disk drive 110 and executes them so that detecting unit 100A, measuring unit 100B, first determining unit 100C, second determining unit 100D, count unit 100E, third determining unit 100F and storage control unit 100G are implemented. Thus, detecting unit 100A, measuring unit 100B, first determining unit 100C, second determining unit 100D, count unit 100E, third determining unit 100F and storage control unit 100G are functions that are held by CPU 100 of image forming apparatus MFP.

Memory 105 is implemented by S-RAM 104, NV-RAM 106 or hard disk drive 110. Memory 105 stores the address of the displayed Web page as the browse address, e.g., in S-RAM 104. Memory 105 selectively stores the addresses of the displayed Web pages (first web pages). More specifically, when operation unit 136 accepts a predetermined operation command during display of a Web page (second Web page), memory 105 stores the address of the second Web page in NV-RAM 106 or hard disk drive 110 as the historical address.

Thus, memory 105 according to the embodiment holds, as the historical addresses, the addresses that are included among the temporarily stored browse addresses and satisfy predetermined conditions.

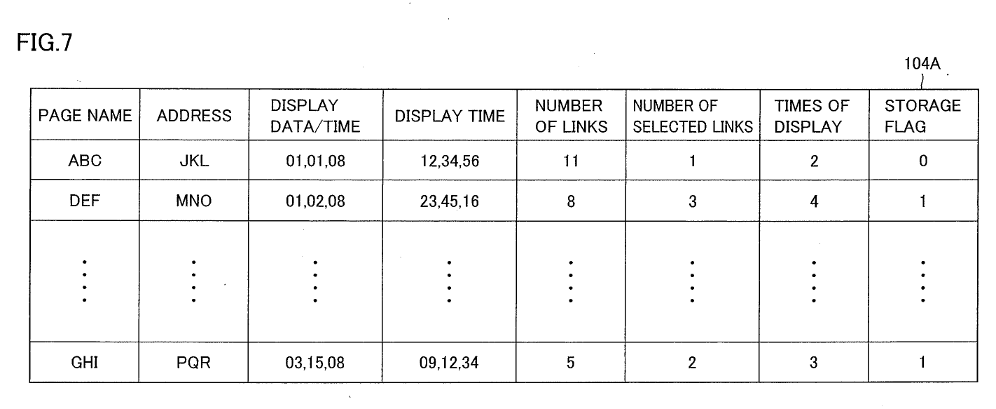

FIG. 7 is an image diagram showing a data structure of browse address data 104A stored in memory 105. Referring to FIGS. 6 and 7, in image forming apparatus MFP according to the embodiment, S-RAM 104 implementing memory 105 nonvolatilely stores browse address data 104A. browse address data 104A stores, for each of the Web pages displayed by display 138 (i.e., received by communication interface 122), a page name of the Web page, the address of Web page (browse address), date and time of display of the Web page, a time or duration of display of the Web page, the number of links included in the Web page, the number of links selected through operation unit 136, the number of times of display of the Web page and a flag indicating ON/OFF of a storage flag.

When storage control unit 100G determines that the address of the downloaded Web page is to be stored as the historical address, the storage flag of the Web page is turned on.

NV-RAM 106 or hard disk drive 110 implementing memory 105 nonvolatilely stores historical address data 106A. Historical address data 106A may bear only the addresses and page names of the Web pages of which addresses are determined by storage control unit 100G to be stored as the historical addresses. Alternatively, historical address data 106A may has substantially the same data structure as browse address data 104A, and only the data relating to the Web pages of which storage flags are ON may be stored.

However, storage control unit 100G may store the address of the Web page in S-RAM 104 as the historical address in a fashion that allows externally calling even after the downloading of the Web page ends. Also, storage control unit 100G may store the address of the Web page in NV-RAM 106 or hard disk drive 110 as the historical address. Further, storage control unit 100G may store the address of the Web page in S-RAM 104, NV-RAM 106 or hard disk drive 110 as the historical address in a fashion that allows externally calling even after the operation of the Web browser ends.

Returning to FIG. 6, detecting unit 100A detects the fact that operation unit 136 accepts the predetermined operation command during display of the Web page.

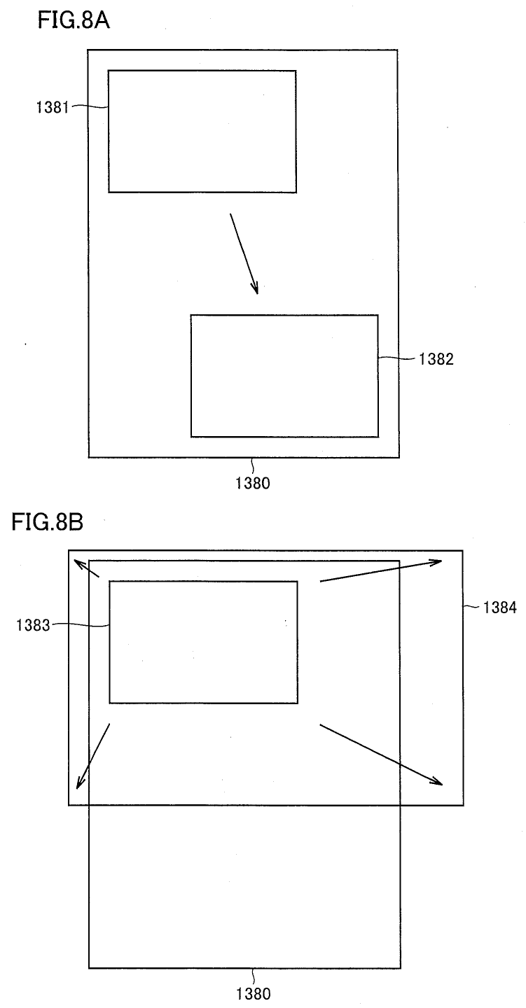

The predetermined operation command includes a command for changing the display area. FIG. 8A is an image view showing a state of scrolling the display area. FIG. 8B is an image view showing a state of expanding the display area.

Referring to FIG. 8A, display 138 partially displays a whole area 1380 of the Web page downloaded from Web server SRV, and specifically displays a first display area 1381 corresponding to the size of display 138. Display 138 changes the display area when it accepts the scroll command for page scrolling entered by the user through operation unit 136. Thus, display 138 displays a second display area 1382 corresponding to the size of display 138 when it accepts the scroll command.

Referring to FIG. 8B, display 138 partially displays whole area 1380 of the Web page downloaded from Web server SRV, and specifically displays a third display area 1383 corresponding to a size of display 138. Display 138 changes a scale of the display area in response to acceptance of a display scale changing command entered by the user through operation unit 136. More specifically, display 138 displays a fourth display area 1384 of the Web page at a changed scale. FIG. 8B shows the state where display 138 displays fourth display area-1384 larger than third display area 1383 in response to the change command for scale-down.

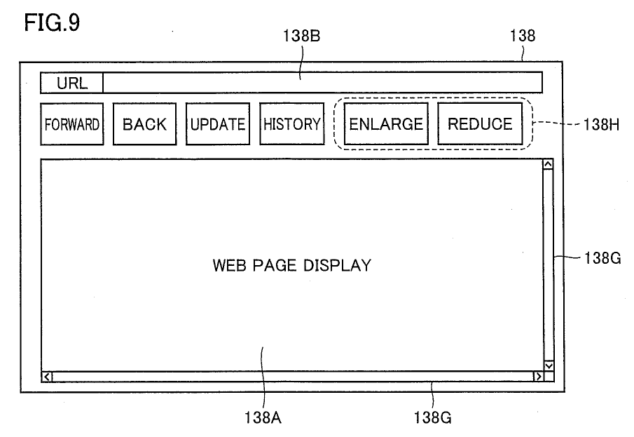

FIG. 9 is a second image view showing a display screen of display 138 in a normal mode. Referring to FIG. 9, display 138 displays, in the normal mode, Web page display area 138A, address input area 138B and operation buttons 138C. More specifically, in the normal mode, display 138 displays a scroll bar 138G and display scaling buttons 138H in addition to history display button 138D and back button 138F.

Referring to FIGS. 8A and 9, when the apparatus accepts movement of scroll bar 138G by the user, display 138 changes the display area from first display area 1381 to second display area 1382. Referring to FIGS. 8B and 9, when he apparatus accepts touch of display scaling button 138H (display reduction button) by the user, display 138 changes the display area to fourth display area 1384 larger than third display area 1383. Conversely, when the apparatus accepts the touch of display scaling button (display enlarge button) 138H by the user, display 138 changes the display area to third display area 1383 smaller than fourth display area 1384,

Returning to FIG. 6, the predetermined operation command accepted by operation unit 136 may include a command for changing the display size of fonts. Alternatively, the predetermined operation command may include a command for searching the Web page. Also, the predetermined operation command may include a command for printing the currently displayed Web page by printer 116.

The Web pages selected by the foregoing user's operations are likely to contain contents that attracted the user's interest. Therefore, image forming apparatus MFP according to the embodiment stores the address of such Web pages as the historical addresses, and thereby can efficiently hold the historical addresses.

Based on the time data provided from clock IC 108, measuring unit 100B measures the display time (i.e., duration) for which display 138 displays the Web page. Measuring unit 100B stores the display time of each Web page in browse address data 104A.

First determining unit 100C determines for each Web page whether the display time reaches a first predetermined time or not. Thus, first determining unit 100C determines whether the user has browsed the Web page in question for at least a predetermined time or more, or not, and regards that the user expressed interest in the Web page of which display time exceeded the predetermined time.

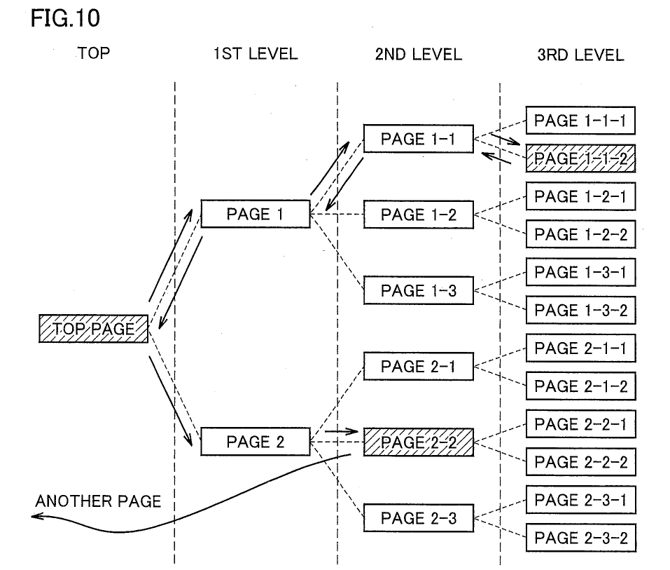

FIG. 10 is a first image diagram showing a hierarchical relationship of the addresses of Web pages downloaded from Web server SRV. Referring to FIG. 10, the Web site has a hierarchical structure including a plurality of Web pages linked together. Usually, the user advances to a deep level by following links. Before the user reaches an intended Web page, there are unintended Web pages merely regarded as passing points. Image forming apparatus MFP according to the embodiment does not store these Web pages as the historical addresses, and thereby stores only the addresses of the Web pages of great importance as the historical addresses.

For example, it is assumed that two Web pages 1 and 2 are linked to a top page. Three Web pages 1-1, 1-2 and 1-3 are linked to page 1. Three Web pages 2-1, 2-2 and 2-3 are linked to page 2. Further, each of the Web pages in the second level is linked to two Web pages.

For example, when the user starts the Web page browsing from the top page and successively browses pages 1, 1-1, 1-1-2, 1-1, 1 and the top page in this order, image forming apparatus MFP according to the embodiment determines that the top page is an entrance of the Web site and is the Web page of great importance. Since the Web page in the deepest level is page 1-1-2 in the third level, image forming apparatus MFP determines that the page 1-1-2 is an intended Web page of the user and is the Web page of great importance, similarly to the top page.

When the user subsequently browses the top page, pages 2 and 2-2, and other Web pages, the second level of page 2-2 is the deepest level so that image forming apparatus MFP according to the embodiment determines that the page 2-2 is the Web page of the great importance.

According to the above examples of browsing, since an ordinary image forming apparatus stores all the addresses of the browsed Web pages, the apparatus must store the addresses of six Web pages, i.e., the top page and pages 1, 2, 1-1, 2-2 and 1-1-2. Conversely, image forming apparatus MFP according to the embodiment stores only the top page and the Web page in the deep level as the historical addresses so that it is required to store only the addresses of three Web pages, i.e., top page and pages 2-2 and 1-1-2. Thus, the apparatus efficiently stores the addresses of the Web page so that the user can easily find the address of the intended Web page later.

Description will now be given in greater detail. The user downloads the top page from Web server SRV through operation unit 136 to display the top page by display 138. By selecting the link from the top page, the user downloads page 1 through communication interface 122 to display page 1 by display 138. By selecting the link of page 1, the user downloads page 1-1 through communication interface 122 to display page 1-1 by display 138. By selecting the link of page 1-1, the user downloads page 1-1-2 through communication interface 122 to display page 1-1-2 on display 138.

Then, the user touches “back” button 138 or selects the link to page 1-1-2 so that display 138 displays page 1-1 again. The user touches “back” button 138 or selects the link to page 1-1 so that display 138 displays page 1-1 again. The user touches “back” button 138 or selects the link of page 1 so that display 138 displays the top page again.

Then, the user selects the link from the top page and downloads page 2 through communication interface 122 to display page 2 by display 138. By selecting the link of page 2, the user downloads page 2-2 through communication interface 122 to display page 2-2 by display 138. By selecting the link of page 2-2, the user downloads another Web page through communication interface 122 to display it by display 138.

Referring to FIGS. 6 to 10, second determining unit 100D determines whether the level of the address corresponding to the newly displayed Web page is deeper than the level of the address corresponding to the last displayed Web page or not. For example, when display 138 displays page 1-1-2 after displaying page 1-1, second determining unit 100D determines that the level of the address corresponding to the newly displayed Web page is deeper than the level of the address corresponding to the last displayed Web page. Conversely, when display 138 displays page 1-1 after displaying page 1-1-2 or displays another Web page after displaying page 2-2, second determining unit 100D determines that the level of the address corresponding to the newly displayed Web page is not deeper than the level of the address corresponding to the last displayed Web page.

More specifically, based on whether the address corresponding to the newly displayed Web page includes the address corresponding to the last displayed Web page or not, second determining unit 100D determines whether the level of the address corresponding to the newly displayed Web page is deeper than the level of the address corresponding to the last displayed Web page or not. Thus, when the address corresponding to the newly displayed Web page includes the address corresponding to the last displayed Web page, second determining unit 100D determines that the level of the address corresponding to the newly displayed Web page is deeper than the level of the address corresponding to the last displayed Web page.

Returning to FIG. 6, count unit 100E counts the links that are selected through operation unit 136 by the user from among the links included in each Web page.

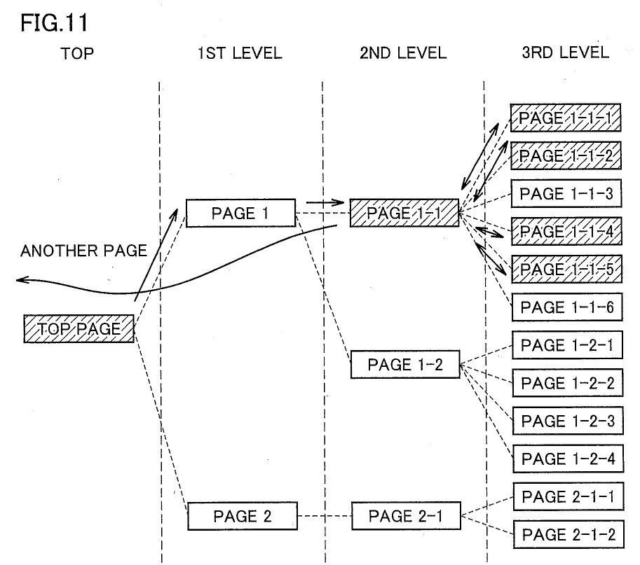

FIG. 11 is a second image diagram showing the hierarchical relationship of the addresses of Web pages downloaded from Web server SRV. Referring to FIG. 11, the Web site has the top page to which two Web pages 1 and 2 are linked. Page 1 is linked to pages 1-1 and 1-2. Page 1-1 has six links, and page 1-2 has four links.

For example, the user starts the browsing from the top page, and browses pages 1 and 1-1. After browsing page 1-1, the user browses the four Web pages 1-1-1, 1-1-2, 1-1-4 and 1-1-1, and returns to page 1-1. Similarly to the case shown in FIG. 10, when the user browses a Web page higher by one level than a last Web page, image forming apparatus MFP according to the embodiment determines that the last Web page in the lower level is of great importance. Therefore, image forming apparatus MFP stores the addresses of the Web pages of pages 1-1-1, 1-1-2, 1-1-4 and 1-1-5 as the historical addresses.

Further, image forming apparatus MFP determines that page 1-1 is the Web page of great importance because the user browsed a plurality of Web pages linked to page 1-1.

Referring to FIGS. 6, 7 and 11, description will now be given further in detail. The user downloads the top page from Web server SRV through operation unit 136, and display 138 displays the top page. By selecting the link from the top page, the user downloads page 1 through communication interface 122, and display 138 displays page 1. In this processing, count unit 100E increments the number of the selected links corresponding to the top page in browse address data 104A.

The user selects the link of page 1, and thereby downloads page 1-1 through communication interface 122 to display page 1-1 on display 138. In this processing, count unit 100E increments the number of selected links corresponding to page 1 in browse address data 104A.

By selecting the link of page 1-1, the user downloads page 1-1-1 through communication interface 122, and display 138 displays page 1-1-1. In this processing, count unit 100E increments the number of selected link(s) corresponding to page 1-1 in browse address data 104A (and the number of selected link becomes 1).

By touching “back” button 138, or selecting the link of page 1-1-1, display 138 displays page 1-1 again. When the user selects the link to page 1-1-1, count unit 100E increments the number of selected link(s) corresponding to page 1-1-1 in browse address data 104A.

By selecting the link of page 1-1, the user downloads page 1-1-2 through communication interface 122, and display 138 displays page 1-1-2. In this processing, count unit 100E increments the number of selected link(s) corresponding to page 1-1 in browse address data 104A again (and the number of selected links becomes 2).

By touching “back” button 138, or selecting the link of page 1-1-2, display 138 displays page 1-1 again. When the user selects the link to page 1-1-2, count unit 100E increments the number of selected link(s) corresponding to page 1-1-2 in browse address data 104A.

By selecting the link of page 1-1, the user downloads page 1-1-4 through communication interface 122, and display 138 displays page 1-1-4. In this processing, count unit 100E increments the number of selected links corresponding to page 1-1 in browse address data 104A again (and the number of selected links becomes 3).

By touching “back” button 138, or selecting the link of page 1-1-4, display 138 displays page 1-1 again. When the user selects the link to page 1-1-4, count unit 100E increments the number of selected links corresponding to page 1-1-4 in browse address data 104A.

By selecting the link of page 1-1, the user downloads page 1-1-5 through communication interface 122, and display 138 displays page 1-1-5. In this processing, count unit 100E increments the number of selected links corresponding to page 1-1 in browse address data 104A again (and the number of selected links becomes 4).

By touching “back” button 138, or selecting the link of page 1-1-5, display 138 displays page 1-1 again. When the user selects the link to page 1-1-5, count unit 100E increments the number of selected links corresponding to page 1-1-5 in browse address data 104A.

By selecting the link of page 1-1, the user downloads another Web page through communication interface 122, and display 138 displays this downloaded page. In this processing, count unit 100E increments the number of selected links corresponding to page 1-1 in browse address data 104A again (and the number of selected links becomes 5).

Referring to FIG. 6, third determining unit 100F determines whether the number of the links selected for each Web page reaches a predetermined number or not. For example, third determining unit 100F determines whether the number of the selected links becomes three or more, or not. Alternatively, third determining unit 100F may determine the importance of the Web page based on the number of times of browsing by the user per Web page, i.e., the number of times of display by display 138.

Operation unit 136 may accept predetermined operation commands while some of the Web pages are being displayed by display 138, and storage control unit 100G stores the addresses corresponding to such some web pages in memory 105 as the historical addresses. When the display time (i.e., duration) of the Web page reaches a predetermined time, storage control unit 100G stores the address corresponding to this Web page as the historical address in memory 105. In addition to the predetermined operation commands, the browse time may be used as the conditions for such storage, whereby image forming apparatus MFP according to the embodiment can store the historical addresses more appropriately.

After the display of the Web page starts, storage control unit 100G stores the address corresponding to the first displayed Web page (top page) as the historical address in memory 105. The Web page that is displayed first after the start of display of the Web page is the Web page that is displayed subsequently to a home page that is registered in image forming apparatus MFP and is displayed when the Web browser starts up. For example, when the file name of the downloaded Web page includes “index.html” or “default.htm”, storage control unit 100G may determine the corresponding Web page as the top page.

Storage control unit 100G stores, as the historical address in memory 105, the address corresponding to the Web page that is displayed at the end of display of the Web page.

When the level of the address corresponding to the newly displayed Web page is not deeper than the level of the address corresponding to the last displayed Web page, storage control unit 100G stores the address corresponding to the last displayed Web page as the historical address in memory 105.

Storage control unit 100G stores, as the historical address in memory 105, the address corresponding to the Web page of which selected links reaches a predetermined value in number.

When printer 116 to be described later prints out the historical address, Storage control unit 100G deletes the printed historical address from memory 105.

When printer 116 to be described later prints the Web page, storage control unit 100G stores the address corresponding to this Web page as the historical address.

Printer 116 accepts the command for printing the Web page through operation unit 136, and prints the Web page. Printer 116 accepts the command for printing the historical addresses through operation unit 136, and prints the historical addresses based on historical address data 106A stored in memory 105. When the historical addresses are to be printed on the paper, many paper sheets are required when there are many the historical addresses. However, image forming apparatus MFP according to the embodiment prints only the addresses of the Web pages determined to be of great importance so that required paper sheets can be reduced in number,

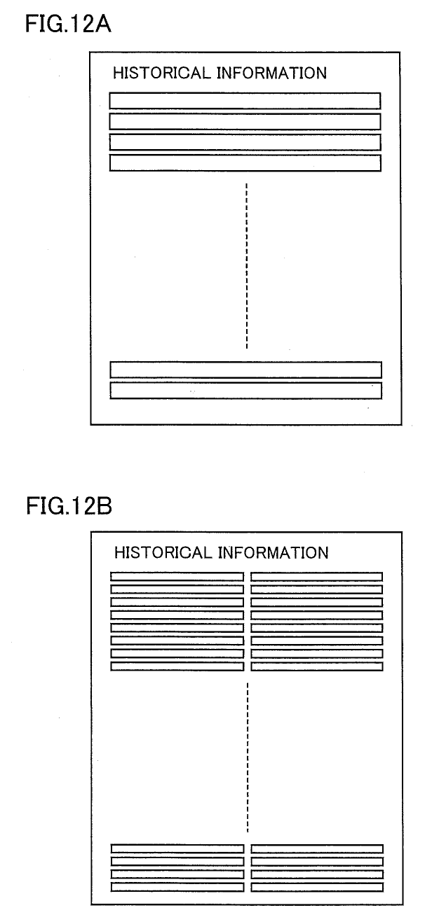

FIG. 12A is first image diagram showing the historical addresses printed by printer 116. FIG. 12B is a second image view showing the historical addresses printed by printer 116.

When printer 116 can print all the historical addresses on a specified sheet, it prints the historical addresses (including addresses and page names of the Web pages) in one column using an ordinary font size. When all the historical addresses cannot be printed on the specified sheet, printer 116 prints the historical addresses in multiple columns using a font size smaller than the ordinary size.

<Address Storage Processing>

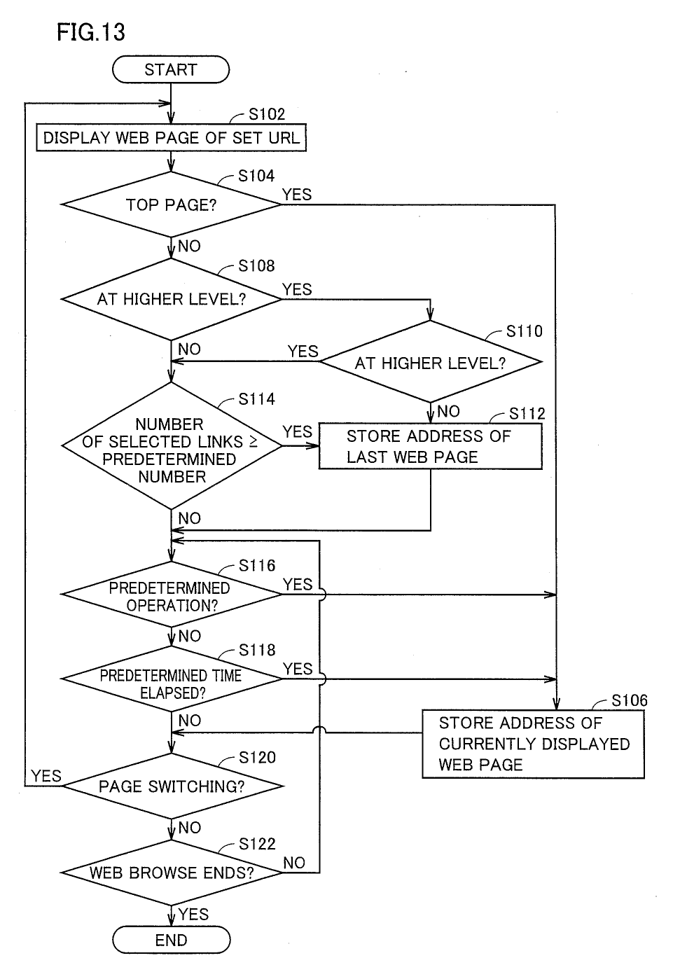

Then, the address storing processing in image forming apparatus MFP according to the embodiment will be described below. FIG. 13 is a flowchart showing a processing procedure of address storage processing in image forming apparatus MFP according to the embodiment.

Referring to FIG. 13, when the Web browser starts, CPU 100 downloads the Web page corresponding to the address entered through operation unit 136 from Web server SRV, and displays this Web page on display 138 (step S102). CPU 100 determines whether the displayed Web page is the top page or not (step S104). Thus, CPU 100 determines whether the displayed Web page is the Web page displayed first after the start of display of the Web page (i.e., after the start of the Web browser) or not.

When the displayed Web page is the top page (YES in step S104), CPU 100 stores the address of the currently displayed Web page as the historical address in historical address data 106A (S106). CPU 100 accepts the command for switching the page (step S120).

When the displayed Web page is not the top page (NO in step S104), CPU 100 determines whether the currently displayed Web page is at the higher level than the last displayed Web page or not (step S108). Thus, it determines whether the level of the address of the currently displayed Web page is not deeper than that of the address of the last displayed Web page or not.

When the currently displayed Web page is at the higher level than the last displayed Web page (YES in step S108), CPU 100 determines whether the last displayed Web page is at the higher level than the second-last displayed Web page (i.e., the Web page immediately preceding the last displayed Web page) or not (step S110).

When the currently displayed Web page is at the higher level than the last displayed Web page (YES in step S108), or when the last displayed Web page is at the higher level than the second-last displayed Web page (YES in step S110), CPU 100 determines whether the number of selected links of the past displayed Web page is equal to a predetermined number or more, or not (step S114).

When the last displayed Web page is at the higher level than the second-last displayed Web page (YES in step S110), or when the number of the selected links of the last displayed Web page is smaller than the predetermined number (YES in step S114), CPU 100 stores the address of the last displayed Web page as the historical address in historical address data 106A (step S112).

Then, CPU 100 determines whether it accepts the predetermined operation through operation unit 136 or not (step S116). When CPU 100 accepts the predetermined operation (step S116), it stores the address of the currently displayed Web page as the historical address in historical address data 106A (step S106).

When the predetermined operation is not accepted (NO in step S116), CPU 100 determines whether the display time of the displayed Web page reaches a predetermined time or not (step S118). When the display time of the displayed Web page reaches the predetermined time (YES in step S118), CPU 100 stores the address of the displayed Web page as the historical address in historical address data 106A (step S106).

When the display time of the displayed Web page does not reaches the predetermined time (NO in step S118), CPU 100 waits for a command for switching the page through operation unit 136 (step S120). When CPU 100 accepts the page switching command (YES in step S120), it downloads the Web page based on a new set address based on the set address. Then, CPU 100 repeats the processing starting from step S102.

When CPU 100 does not accept the page switching command (NO in step S120), it waits for a command for ending the Web browser through operation unit 136 (step S122). When CPU 100 accepts the command for ending the Web browser (YES in step S122), it ends the Web browser. When CPU 100 does not accept the command for ending the Web browser (NO in step S122), it repeats the processing starting from step S116.

Image forming apparatus MFP according to the embodiment has all the functions for performing the determination in steps S110, S114, S116 and S118, but may have only one or some of the above determination functions.

More specifically, image forming apparatus MFP has one or some of the above determination functions as well as a function of storing the addresses of Web pages as the historical addresses based on the determination results. A memory capacity required for storing the Web addresses can be small so that image forming apparatus MF can efficiently store the historical addresses. Image forming apparatus MFP thus configured does not store unnecessary Web addresses as the historical addresses so that the user can efficiently access the historical addresses.

<Historical Address Printing Processing>

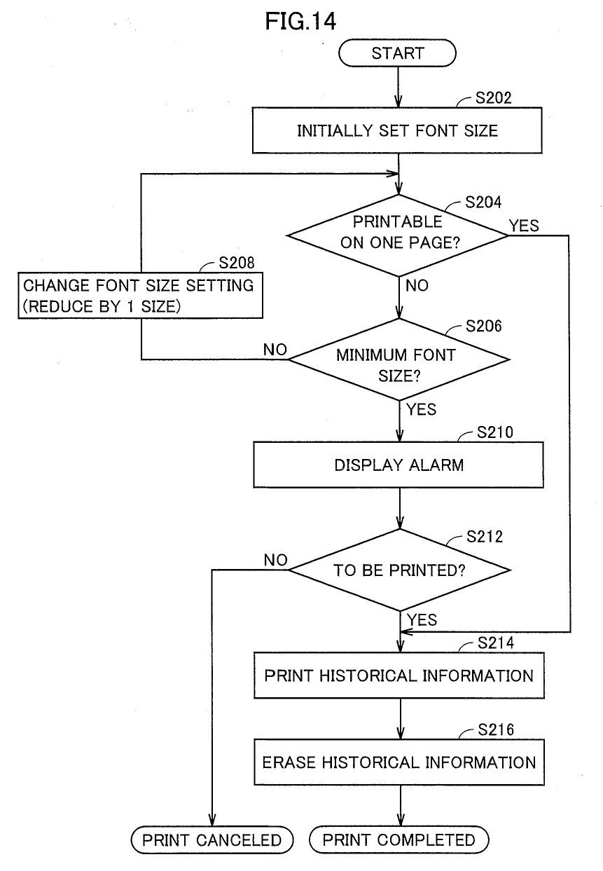

Then, description will be given on the historical address printing processing in image forming apparatus MFP according to the embodiment. FIG. 14 is a flowchart showing a processing procedure of the historical address printing processing in image forming apparatus MFP.

Referring to FIG. 14, CPU 100 accepts the setting of the font size through operation unit 136 (step S202). Then, CPU 100 refers to historical address data 106A and determines, based on the number of the historical addresses stored in memory 105, the font size and the paper sheet size, whether all the historical addresses stored in memory 105 can be printed on one paper sheet or not (step S204).

When all the historical addresses stored in memory 105 can be printed on one paper sheet (YES in step S204), CPU 100 causes printer 116 to print the historical addresses based on historical address data 106A (step S214). CPU 100 deletes the historical addresses printed by printer 116 from memory 105 (step S216), and ends the historical address printing processing.

When all the historical addresses stored in memory 105 cannot be printed on one paper sheet (NO in step S204), CPU 100 determines whether the currently set font size is the minimum size or not (step S206). Thus, CPU 100 determines whether the font size cannot be reduced further or not. When the currently set font size is not the minimum size (NO in step S206), CPU 100 reduces the font size by one size (step S208), and repeats the processing starting from step S204.

When the currently set font size is the minimum (YES in step S206), CPU 100 causes display 138 to display an alarm that all the historical addresses cannot be printed on one paper sheet (step S210). CPU 100 determines whether it accepts the command for executing the printing through operation unit 136 or not (step S212). When it accepts the command for executing the printing (YES in step S212), CPU 100 causes printer 116 to print the historical addresses based on historical address data 106A (step S214).

In this processing, CPU 100 causes printer 116 to print the historical addresses in multiple columns (see FIG. 12B). CPU 100 deletes the historical addresses printed by printer 116 from memory 105 (step S216), and ends the historical address printing processing.

When CPU 100 does not accept the command for executing the printing (NO in step S212), CPU 100 ends the historical address printing processing.

### Second Embodiment

Then, a second embodiment will be described below. Image forming apparatus MFP according to the first embodiment already described determines the importance of the Web page every time the Web page is displayed, and stores the address of the important Web page as the historical address in memory 105.

Conversely, image forming apparatus MFP according to the embodiment determines the importance of the Web page when the Web page is displayed, and stores, for each Web page, information indicating whether the address of the Web page is to be held or not. Alternately, image forming apparatus MFP according to the embodiment determines the importance of the Web page when the Web page is displayed, and stores, for each Web page, the information indicating whether the address of the Web page is to be deleted or not,

Image forming apparatus MFP according to the embodiment collectively stores the addresses of the Web pages of great importance in memory 105 as the historical addresses according to predetermined timing. Alternatively, image forming apparatus MFP according to the embodiment temporarily stores the addresses of all the displayed Web pages in memory 105, and then collectively deletes the addresses of the Web pages of low importance according to predetermined timing so that it stores the addresses of the Web pages of great importance in memory 105.

The whole structure of the image forming system and the hardware structure of image forming apparatus MFP according to the second embodiment are the same as those in the first embodiment shown in FIGS. 1 to 5, and therefore description thereof is not repeated.

<Functional Structure>

Then, image forming apparatus MFP according to the second embodiment will be described below. The functional structure of image forming apparatus MFP according to the embodiment will be described below with reference to FIG. 6. Description of the functional blocks that are the same as those of image forming apparatus MFP in the first embodiment is not repeated.

Referring to FIG. 6, in image forming apparatus MFP according to the embodiment, detecting unit 100A turns on the storage flag of the displayed Web page in browse address data 104A when operation unit 136 accepts a predetermined operation command. In browse address data 104A, first determining unit 100C turns on the storage flag of the Web page of which display time reaches a predetermined time.

When the level of the address corresponding to the newly displayed Web page is not deeper than the level of the address corresponding to the last displayed Web page, second determining unit 100D turns on the storage flag of the last displayed Web page in browse address data 104A. Third determining unit 100F turns on the storage flag of the Web page of which selected links reach a predetermined value in number.

Storage control unit 100G turns on the storage flag of the first displayed Web page in browse address data 104A after the display of the Web page starts. Storage control unit 100G turns on the storage flag of the Web page displayed when the display of the Web page ends. Further, storage control unit 100G turns on the storage flag of the Web page when printer 116 prints the Web page.

Storage control unit 100G according to the embodiment refers to browse address data 104A, and deletes, from memory 105, the address of the Web page of which storage flag is OFF, according to predetermined timing. When printer 116 prints the historical address, storage control unit 100G deletes the printed historical address from memory 105.

The predetermined timing includes the time when the display of the Web page ends, i.e., when the Web browser ends. This is because there is relatively high possibility that the user browses the previously browsed Web page again, until the Web browser ends. Also, there is relatively low possibility that the user browses the previously browsed Web page again, after the Web browser ended once.

The predetermined timing includes the time when the display time of the Web page reaches a second predetermined time. The predetermined timing includes the time when the data amount of browse address data 104A stored in memory 105 reaches the predetermined value. This is because it is not necessary to restrict the stored historical address when the historical address stored in memory 105 is small in quantity.

<Address Storage Processing>

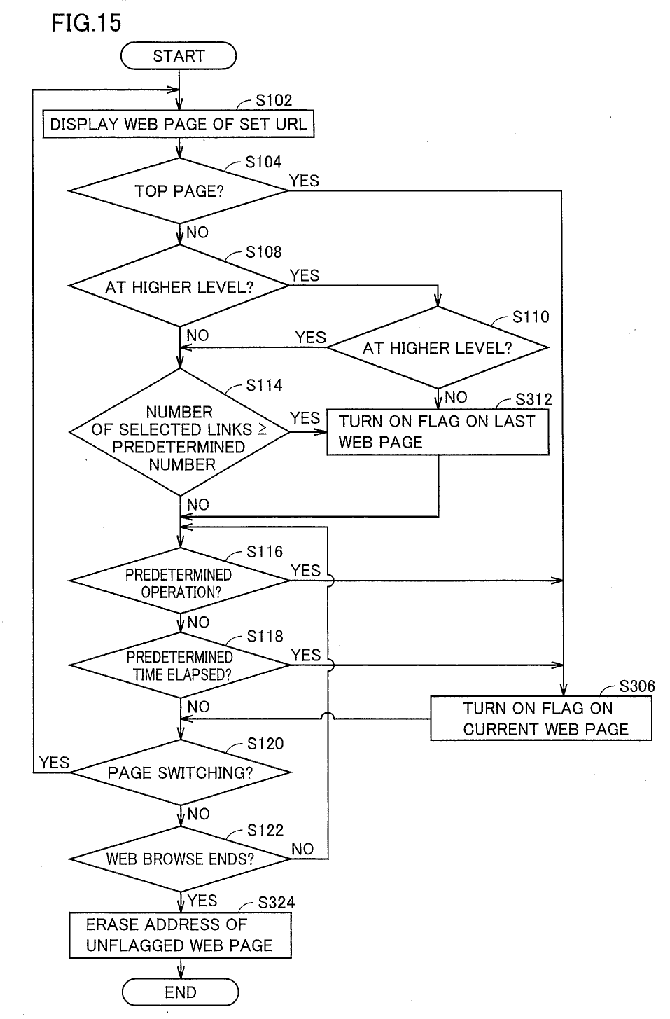

Then, description will be given on the processing procedure of the address storing processing in image forming apparatus MFP according to the embodiment. FIG. 15 is a flowchart showing the processing procedure of the address storing processing in image forming apparatus MFP according to the second embodiment. In the flowchart of FIG. 15, the steps performed for the same processing as the steps in the flowchart of the first embodiment shown in FIG. 13 bear the same step numbers, and description thereof is not repeated.

Referring to FIG. 15, when the displayed Web page is the top page (YES in step S104), CPU 100 turns on the storage flag of the currently displayed Web page in browse address data 104A (S306).

When the last displayed Web page is at the higher level than the second-last displayed Web page (YES in step S110), or when the number of the selected links of the last displayed Web page is smaller than the predetermined number (YES in step S114), CPU 100 turns on the storage flag of the last displayed Web page in browse address data 104A (step S312).

When CPU 100 accepts the predetermined operation (step S116), it turns on the storage flag of the currently displayed Web page (step S306). When the display time of the displayed Web page reaches the predetermined time (YES in step S118), it turns on the storage flag of the displayed Web page (step S306).

When CPU 100 accepts the command for ending the Web browser (YES in step S122), it deletes, from browse address data 104A, the data of the Web pages of which storage flags are not on, and thereby memory 105 holds, as the historical addresses, the addresses of the Web pages of which storage flags are on (step S324). Then, CPU 100 ends the Web browser,

Image forming apparatus MFP according to the embodiment has all the functions for forming the determinations in steps S108, S110, S114, S116 and S118, but may be configured to have one or some of these determination functions.

In image forming apparatus MFP that has one or some of the above determination functions as well as the function of storing the addresses of the Web pages as the historical addresses based on the result of such determination, it is possible to reduce the memory capacity required for storing the Web addresses, and therefore the historical addresses can be stored efficiently. Since image forming apparatus MFP does not store the unnecessary Web addresses as the historical addresses, the user can efficiently access the historical addresses.

### Other Embodiments

The program according to the invention may be configured to call predetermined necessary modules in a predetermined sequence or order according to predetermined timing from among the program modules that are provided as a part of the Operating System (OS) of the computer, and thereby to execute the processing. In this case, the program itself does not include the above modules, and cooperates with the OS to execute the above processing. The program according to the invention also includes the above program not including such modules.

The program according to the invention may be provided by incorporating it into a different program. In this case, the program itself does not include the modules included in the different program, and cooperates with the different program for executing the processing. The program according to the invention likewise includes the above program incorporated into the different program.

The provided program product is installed for execution in a program storage unit such as a hard disk drive. The program product includes a program itself and a recording medium recording the program.

A part or whole of the functions implemented by the program according to the invention may be configured by dedicated hardware.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image forming apparatus comprising:
a memory;
an operation unit for accepting first and second commands;
a communication interface for receiving a Web page from an external address over said network based on said first command;
a display for displaying the received Web page;
a detecting unit for detecting input of said second command relating to said Web page during display of said Web page; and
a storage control unit for storing an address of said Web page as historical information in said memory, when the detecting unit detects input of said second command relating to said Web page during display of said Web page.

2. The image forming apparatus according to claim 1, wherein
said second command relating to said Web page includes a command for changing a display area.

3. The image forming apparatus according to claim 1, wherein
said second command relating to said Web page includes a command for changing a display size of a font.

4. The image forming apparatus according to claim 1, wherein
said second command relating to said Web page includes a command for searching a word on said Web pages.

5. The image forming apparatus according to claim 1, wherein
said storage control unit stores the address of the first displayed Web page as said historical information in said memory.

6. The image forming apparatus according to claim 1, wherein
said storage control unit stores the address of the last displayed Web page as said historical information in said memory.

7. The image forming apparatus according to claim 1, further comprising:
a printer for printing said historical information stored in said memory, wherein
said storage control unit deletes said printed historical information from said memory.

8. The image forming apparatus according to claim 1, further comprising:
a printer for printing said Web page, wherein
said second command relating to said Web page includes a command for printing the currently displayed Web page.

9. The image forming apparatus according to claim 1, wherein
said operation unit accepts a display command for displaying said historical information, and
said display displays said historical information read from said memory in accordance with said display command.

10. An image forming apparatus comprising:
a memory;
an operation unit for accepting an operation command;
a communication interface for receiving a Web page from an external address over a network based on said operation command;
a display for displaying the received Web page;
a measuring unit for measuring a time for which said Web page is displayed;
a first determining unit for determining whether the time of display of said Web page is longer than a first predetermined time or not; and
a storage control unit for storing an address of said Web page as said historical information in said memory, when the time of display of said Web page is longer than a first predetermined time.

11. An image forming apparatus comprising:
a memory;
an operation unit for accepting an operation command;
a communication interface for receiving successively Web pages from an external address over a network based on said operation command;
a display for displaying the received Web page;
a second determining unit for determining whether a level of an address of the newly displayed Web page is deeper than a level of an address of the last displayed Web page or not; and
a storage control unit for storing the address of said last displayed Web page as said historical information in said memory, when the level of the address of said newly displayed Web page is not deeper than the level of the address of said last displayed Web page.

12. An image forming apparatus comprising:
a memory;
a communication interface for successively receiving at least one Web page from an external address over a network based on an operation command;
a display for displaying each of the at least one received Web page;
an operation unit for accepting, as said operation command, a selection command for selecting a link of each of the at least one Web page;
a count unit for counting the number of the selected links of each of the at least one Web page;
a third determining unit for determining whether the number of said selected links is more than a predetermined number or not; and
a storage control unit for storing the address of the Web page having said selected links as said historical information in said memory, when the number of said selected links is more than the predetermined number.

13. An address storing method in an image forming apparatus including a memory, a display and a communication interface, comprising the steps of:
receiving a Web page from an external address through said communication interface over a network based on a first command;
displaying the received Web page on said display;
detecting acceptance of a second command relating to said Web page during display of said Web page; and
storing an address of said Web page as historical information in said memory, when accepting said second command relating to said Web page during display of said Web page.

14. The address storing method according to claim 13, wherein
said second command relating to said Web page includes a command for changing a display area.

15. The address storing method according to claim 13, wherein
said second command relating to said Web page includes a command for changing a display size of a font.

16. The address storing method according to claim 13, wherein said second command relating to said Web page includes a command for searching a word on said Web pages.

17. The address storing method according to claim 13, further comprising:
a step of storing the address of the first displayed Web page as said historical information in said memory.

18. The address storing method according to claim 13, further comprising:
a step of storing the address of the last displayed Web page as said historical information in said memory.

19. The address storing method according to claim 13, wherein
said image forming apparatus includes a printer; and
said address storing method further comprises the steps of:
printing said historical information stored in said memory by said printer; and
erasing said printed historical information from said memory.

20. A computer-readable recording medium recording an address storing program for causing an image forming apparatus including a processor, a memory, a display and a communication interface, to store an address,
said address storing program causes said processor to execute the steps of:
receiving a Web page from an external address through said communication interface over a network based on a first command;
displaying the received Web page on said display;
detecting acceptance of a second command relating to said Web page during display of said Web page; and
storing an address of said Web page as historical information in said memory, when accepting said second command relating to said Web page during of said Web page.
